(19) United States
(12) Patent Application Publication
(10) Pub. No.: US 2026/0265556 A1
(43) Pub. Date: Sep. 10, 2026

(54) INK COMPOSITIONS FACILITATING LOW-SNEEZE OR SNEEZE-FREE INKJET PRINTING PROCESSES

(71) Applicant: XEROX CORPORATION, Norwalk, CT (US)

(72) Inventors: Mark A. JACKSON, Rochester, NY (US); Jing X. SUN, Lexington, KY (US); James A. WINTERS, Alfred Station, NY (US); David B. PLAYFAIR, Penfield, NY (US); David M. SKINNER, Rochester, NY (US); Lanhui ZHANG, Webster, NY (US); Chieh-Min CHENG, Rochester, NY (US)

(73) Assignee: XEROX CORPORATION, Norwalk, CT (US)

(21) Appl. No.: 19/070,168

(22) Filed: Mar. 4, 2025

(51) Int. Cl. C09D 11/38; C09D 11/326

(52) U.S. Cl. CPC C09D 11/38; C09D 11/326

(57) ABSTRACT

Ink compositions may be formulated to facilitate low-sneeze or no-sneeze inkjet printing. The ink compositions may comprise: a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less, in which the humectant blend comprises about 40 wt % or less of the ink composition based on total mass; optionally, a polymeric dispersant dissolved in the continuous phase; a binder resin dispersed or dissolved in the continuous phase; and a colorant dispersed or dissolved in the continuous phase.

### FIELD

The present disclosure generally relates to inkjet printing, and more specifically, formulation of ink compositions facilitating low-sneeze or sneeze-free printing processes.

### BACKGROUND

Inkjet printers eject liquid ink from a print head onto a print substrate to form an image. Common inkjet print heads include a stack of plates, referred to as a jet stack, with an outermost plate including an array of nozzles for ink dispensation. A driver moves the print head relative to the print substrate to facilitate ink deposition in a desired location. Each nozzle may include a thermal or piezoelectric actuator to promote dispensation of ink droplets onto the print substrate.

An issue commonly encountered with inkjet printing, especially in the case of aqueous inks, is that the ink may at least partially evaporate in the print head, leading to inaccurate printing or even clogging of the print head. Without being bound by theory or mechanism, the foregoing issues are believed to result from an increased ink viscosity following evaporation, which may lead to low-velocity droplet ejection and/or smaller than expected droplet volumes, including no droplet ejection at all (clogging). Clogging of the print head is not an uncommon occurrence while an inkjet printer is sitting idle over a period of days to weeks; however, ink evaporation and print nozzle clogging can occur even while a printing process is ongoing if a nozzle is not being emptied regularly, even over very short time intervals. Various strategies for combating evaporation of the ink in the print head and the resulting print nozzle clogging may include design modifications of the print heads or print nozzles, changing operating parameters during printing, and/or formulation of modified inks that are less susceptible to evaporation in the print head.

During a printing process, print heads may need to fire regularly to introduce fresh ink in order to limit ink evaporation and to prevent print nozzle clogging. One approach for introducing fresh ink to a print nozzle during a printing process is to periodically eject a single ink droplet at an inconspicuous location on the print substrate. The location and print density of the ejected ink droplets are designed to be below the visibility threshold of a viewer. This process may be referred to as “sneezing” or “background jetting.” Ink droplets dispensed during a sneezing operation may also be located within an image being printed upon the print substrate, again with the sneezed ink droplets remaining inconspicuous to a viewer. When performed, sneezing may take place at regular intervals under control of operating software of the inkjet printer.

While sneezing may be utilized to maintain the print nozzles in a healthy state during extended inkjet printing processes, there are some undesirable issues associated with sneezing. First, a prim substrate has to be present to receive ink droplets released during a sneezing process. Thus, unless continuous print substrates are being used, sneezing may not be applicable at all times during a printing process (i.e., when using individualized print substrates, such as single sheets of paper). Second, sneezing results in added ink usage, which increases raw materials cost associated with printing, and printing speed may also be decreased. Finally, if excessive ink droplets are present in the background portion of a printed image, the image quality may be unacceptably degraded, especially for printing of high-resolution images.

In view of the foregoing, inkjet printing techniques and ink compositions that may minimize or eliminate sneezing are highly desired.

### SUMMARY

In some embodiments, the present disclosure provides ink compositions comprising: a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less; wherein the humectant blend comprises about 40 wt % or less of the ink composition based on total mass; optionally, a polymeric dispersant dissolved in the continuous phase; a binder resin dispersed or dissolved in the continuous phase; and a colorant dispersed or dissolved in the continuous phase.

In some or other embodiments, ink compositions of the present disclosure may comprise: a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less; wherein the humectant blend comprises about 40 wt % or less of the ink composition based on total mass, and the first humectant comprises glycerol; the second humectant comprises 1,2-propanediol, 1,2-butanediol, 1,3-butanediol, or any combination thereof; and the third humectant comprises 1,2-hexanediol; a binder latex comprising a styrene-acrylate copolymer dispersed in the continuous phase; and a pigment dispersed in the continuous phase.

In still other embodiments, printing methods of the present disclosure may comprise: ejecting an ink composition of the present disclosure through a jet stack of an inkjet printer, wherein sneezing is not performed while the inkjet printer is operating; and receiving the ink composition upon a print substrate to form an image.

### BRIEF DESCRIPTION OF THE DRAWINGS

Not applicable.

### DETAILED DESCRIPTION

The present disclosure generally relates to inkjet printing, and more specifically, formulation of ink compositions facilitating low-sneeze or sneeze-free printing processes.

As discussed above, sneezing may be performed in the course of an inkjet printing process to maintain the health of the print nozzles. Namely, by periodically sneezing ink droplets, the print nozzles may be protected against failure to discharge ink droplets or misfiring ink droplets in an incorrect location. Although sneezing may be an effective approach for maintaining print nozzle health, this process results in unproductive ink usage and may decrease the perceived print quality of high-resolution images.

As a solution to the foregoing, the present disclosure provides ink compositions suitable for performing inkjet printing with a decreased amount of sneezing or even no-sneeze printing configurations. Surprisingly, the ink compositions may exhibit better performance relative to commercial inks of various colors when printed in a no-sneeze printing configuration rather than when printed in a standard sneezing configuration (e.g., one- or two-drop sneeze dispensation of ink at regular sneezing intervals). The ability to accomplish printing with decreased sneezing or no sneezing may result in more effective ink usage and potentially faster printing.

To accomplish the foregoing, the ink compositions of the present disclosure utilize a designed humectant blend (mixture of hydrophilic organic solvents) that may aid in facilitating no-sneeze printing. The humectants and water are the major carriers of colorant and other components in the ink compositions described herein. Among other functions, the humectants may increase ink stability during storage, promote ink interaction with the print head to maintain health of the print nozzles, and increase ink penetration into a print substrate (e.g., paper) for better wetting, improved drying times, and increased optical density. Illustrative humectants may include, for example, monohydric alcohols, polyhydric alcohols, alkylene glycols, alkylene glycol monoalkyl or dialkyl ethers, polyalkylene glycols, nitrogen-containing heterocyclic compounds, ketones, esters, lactones, lactams, and the like. A humectant or combination of humectants may be selected to provide compatibility with a specified colorant or other various components present within a given ink composition.

To facilitate sneeze-free printing, the ink compositions of the present disclosure may contain a humectant blend with a balanced degree of hydrophilicity and hydrophobicity. In particular, the ink compositions of the present disclosure may contain a humectant blend comprising a first humectant having a hydrophilic-lipophilic balance (HLB) of about 10 or greater, a second humectant having a HLB ranging from about 7.5 to about 9, and a third humectant having a HLB of about 7 or less. HLB may be calculated based upon known contributions of atoms in the molecular structure to hydrophilicity or lipophilicity. For example, HLB may be calculated by Griffin's Method. Griffin's Method is well known for use in conjunction with determining the HLB of nonionic materials. Using Griffin's Method, the HLB value equals 20 times the summed molecular weight of the hydrophilic portion of a molecule divided by the overall molecular weight. Typically, highly hydrophobic material is defined by a HLB of 3 or less, and a HLB of 8 or more defines a relatively low hydrophobic material. Without being bound by theory or mechanism, the first humectant in the humectant blend may provide a highly hydrophilic and hygroscopic environment to improve print nozzle health during printing latency, the third humectant in the humectant blend, by virtue of its relative hydrophobicity, may promote ink penetration into a print medium, improve drying time, and prevent inter-color bleeding, and the second humectant in the humectant blend may provide a common co-solvent for dissolution of the various ink components. The second humectant may be present in the humectant blend in an amount greater than a combined amount of the first humectant and the third humectant, such as about a 2-fold excess or greater.

Accordingly, ink compositions of the present disclosure may comprise: a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less; optionally, a polymeric dispersant dissolved in the continuous phase; a binder resin dispersed or dissolved in the continuous phase; and a colorant dispersed or dissolved in the continuous phase. The humectant blend comprises about 40 wt % or less of the ink composition based on total mass.

As used herein, the term “dissolved” means that a given component is solubilized to homogeneity, such that if the given component is below its solubility limit, no separate phase of the component remains present in an ink composition.

As used herein, the term “dispersed” means that a given component is substantially undissolved and remains as a separate phase in an ink composition. A component that is dispersed may be suspended in an ink composition, for example.

The polymeric dispersant may be utilized in cases wherein the colorant is not self-dispersible or adequately dispersible, either alone or in combination with one or more surfactants. If present, a polymeric dispersant comprising a water-soluble polymer may be dissolved in the continuous phase to promote dispersion of the colorant, such as pigment particles. Any polymeric dispersant that may satisfactorily disperse pigment particles uniformly or substantially uniformly within the continuous phase may be used in the ink compositions disclosed herein. In non-limiting examples, the polymeric dispersant, if present, may suitably disperse a pigment as small particles having a particle size of about 200 nm or less, or about 150 nm or less, or about 100 nm or less.

If present, the polymeric dispersant may be present in the ink compositions over a wide composition range. In non-limiting examples, a mass ratio of pigment to polymeric dispersant may range from about 20:1 to about 1:1, or about 10:1 to about 1:1, or about 8:1 to about 1:1, or about 6:1 to about 1:1, or about 5:1 to about 1:1, or about 4:1 to about 1:1, or about 10:1 to about 2:1, or about 5:1 to about 3:1.

When used, suitable polymeric dispersants may be anionic and bear one or more carboxylic acid and/or sulfonic acid moieties. The carboxylic acid and/or sulfonic acid moieties may be at least partially deprotonated by virtue of the pH of the continuous phase. In some instances, the polymeric dispersant may have an acid number of about 200 or above and a weight average molecular weight (Mw) of about 7,000 to about 10,000, as measured by gel permeation chromatography. Acid number is measured by titration with potassium hydroxide and is expressed as mg(KOH)/g(polymer).

A binder resin different than the polymeric dispersant may be dissolved or dispersed in the continuous phase. Suitable binder resins may include, for example, base-soluble polymer resins, water-soluble polymer resins, or binder latex polymer resins (polymer emulsions). Base-soluble polymer resins or water-soluble polymer resins may be dissolved in the continuous phase, whereas a binder latex polymer resin may be dispersed in the continuous phase as a plurality of polymer particles. Suitable binder resins are not believed to be particularly limited, provided that the binder resin conveys sufficient mechanical strength to a printed image. Preferably, the binder resin in the present disclosure may comprise at least a binder latex.

In non-limiting examples, the binder resin may be present in the ink compositions of the present disclosure in an amount of about 6 wt % or below, or about 4 wt % or below, based on total mass of the ink composition, such as about 1 wt % to about 5 wt %, or about 2 wt % to about 4 wt %, or about 2 wt % to about 5 wt %.

Suitable base-soluble polymer resins may include, for example, polyurethane durability polymers (Kodak) and polystyrene-acrylic copolymers from BASF. Such polymers may promote film formation to provide print adhesion with abrasion, scratch, light-fade and water/chemical resistance. In some examples, a base-soluble polymer resin may be utilized in combination with a binder latex polymer resin that is not necessarily soluble in base.

Suitable binder latex polymer resins may include, for example, acrylate polymers or copolymers, such as a styrene-acrylate copolymer, preferably further containing at least one acidic monomer, such as acrylic acid, methacrylic acid, styrenesulfonic acid, a phosphonic acid, or the like. Acrylate monomers that may be present in such copolymers include, for example, acrylic acid, methacrylic acid, any combination thereof, or any ester thereof. Preferably, the amount of monomers containing carboxylic acid or sulfonic acid groups in the binder latex polymer resin may be about 15 wt % or more, or about 18 wt % or more, or about 20 wt % or more, based on total mass of the binder latex polymer resin. Styrene-acrylate copolymers may be particularly suitable binder resins due to their good moisture resistance and film-formation properties with good dry rub resistance. Illustrative styrene-acrylate copolymers may include, for example, copolymers of styrene, an acrylate ester (e.g., butyl acrylate), acrylic acid or methacrylic acid, bis[2-(methacryloyloxy)ethyl]phosphate, and 1-dodecanethiol.

In some examples, the binder latex polymer resin may have a particle size of about 150 nm or less, or about 100 nm or less, or about 75 nm or less when dispersed in the continuous phase. Unless otherwise indicated, particle sizes are average particle sizes determined by a NANOFLEX instrument (Microtrac, Inc.) and are on a volume basis.

In some examples, the binder latex may have a glass transition temperature (Tg) of about 40° C. to about 70° C., or about 45° C. to about 60° C., as measured by differential scanning calorimetry. When the glass transition temperature is within these ranges, film formation may occur readily on a printing substrate but not within a nozzle depositing the ink composition upon the printing substrate. The binder latex may have a polydispersity index (Mw/Mn, as determined by gel permeation chromatography) of about 2 to about 4, or about 2.5 to about 3.5, or about 2.5 to about 3.

A colorant may be dissolved or dispersed in the continuous phase to provide a desired coloration state of the ink compositions. Suitable colorants may be organic or inorganic in nature and may comprise a pigment, a self-dispersed pigment, a dye, or any combination thereof. Pigments may be dispersed as solid particles in the ink compositions, whereas dyes may be dissolved or dispersed depending on the components present in the ink compositions. Suitable pigments may include a black pigment, a white pigment, a cyan pigment, a magenta pigment, a yellow pigment, or any combination thereof. Two or more pigments of a specified color may be present to achieve a desired coloration state of the ink compositions. More specific examples of suitable pigments follow below.

Pigments or dyes may be included in the ink compositions in an effective amount to convey desired coloration properties to the ink compositions or images printed therewith. The effective amount may be further selected such that the pigment or dye may be effectively dissolved or dispersed in the continuous phase. In non-limiting examples, the pigment or dye may be included in the ink compositions in an amount ranging from about 0.05 wt % to about 15 wt %, or about 0.1 wt % to about 12 wt %, or about 1 wt % to about 5 wt %, or about 3 wt % to about 10 wt %, based on a total mass of the ink composition.

Pigments may be dispersed as solids within the ink compositions. Suitable particle sizes for a dispersed pigment may include an average particle diameter (D50, volume-weighted mean diameter) of about 200 nm or less, or about 100 nm or less, or about 70 nm or less, such as about 20 nm to about 200 nm, or about 20 nim to about 100 nm, or about 20 nm to about 75 nm, or about 20 nm to about 40 nm, or about 30 nm to about 60 nm, or about 50 nm to about 75 nm. Particle sizes may be determined by a dynamic light scattering particle size analyzer, such as a Malvern Mastersizer instrument, or with a Nanoflex instrument. Suitable pigment particles may be spherical or non-spherical in shape.

Suitable inorganic pigments may include, for example, carbon black, iron black, manganese dioxide, titanium oxide, zinc white, zinc sulfide, antimony white, ultraarine, Persian blue, cobalt blue (CoO—Al₂O), cerulean blue, cerium uranium blue, Egyptian blue, Han blue, azurite, basic copper carbonate, Prussian blue, manganese blue, chrome yellow (PbCrCO₄), orpiment, Primrose yellow, cobalt yellow, strontium yellow, titanium yellow, stannic sulfide, zinc yellow, cerium sulfide red, and iron oxide.

Suitable organic pigments may include, for example, azo pigments including diazo pigments and monoazo pigments, polycyclic pigments (e.g., phthalocyanine pigments such as phthalocyanine blues and phthalocyanine greens), perylene pigments, perinone pigments, anthraquinone pigments, quinacridone pigments, dioxazine pigments, thioindigo pigments, isoindolinone pigments, pyranthrone pigments, and quinophthalone pigments), insoluble dye chelates (e.g., basic dye type chelates and acidic dye type chelates), nitro pigments, nitroso pigments, anthraquinone pigments such as PR168, and the like. Illustrative phthalocyanine blues and greens may include copper phthalocyanine blue, copper phthalocyanine green, and derivatives thereof (Pigment Blue 15. Pigment Green 7, and Pigment Green 36). Illustrative quinacridones may include Pigment Orange 48, Pigment Orange 49, Pigment Red 122, Pigment Red 192, Pigment Red 202, Pigment Red 206, Pigment Red 207, Pigment Red 209, Pigment Violet 19, and Pigment Violet 42, Illustrative anthraquinones may include Pigment Red 43, Pigment Red 194, Pigment Red 177, Pigment Red 216 and Pigment Red 226 Illustrative perylenes include Pigment Red 123, Pigment Red 149, Pigment Red 179, Pigment Red 190, Pigment Red 189 and Pigment Red 224. Illustrative thioindigoids may include Pigment Red 86, Pigment Red 87, Pigment Red 88, Pigment Red 181. Pigment Red 198, Pigment Violet 36, and Pigment Violet 38, Illustrative heterocyclic yellows may include Pigment Yellow 1, Pigment Yellow 3. Pigment Yellow 12, Pigment Yellow 13, Pigment Yellow 14, Pigment Yellow 17, Pigment Yellow 65, Pigment Yellow 73, Pigment Yellow 74, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213.

Illustrative black pigments that may be used include carbon pigments. Suitable carbon pigments may include, for example, carbon black, graphite, vitreous carbon, charcoal, and combinations thereof, Such carbon pigments can be manufactured by a variety of known methods, such as a channel method, a contact method, a furnace method, an acetylene method, or a thermal method, and are commercially available from such vendors as Cabot Corporation, Columbian Chemicals Company, Evonik, and E.I DuPont de Nemours and Company.

Suitable dyes may include food dyes such as Food Black No. 1, Food Black No. 2, Food Red No. 40, Food Blue No. 1, Food Yellow No. 7, FD &. C dyes, Acid Black dyes (No. 1, 7, 9, 24, 26, 48, 52, 58, 60, 61, 63, 92, 107, 109, 118, 119, 131, 140, 155, 156, 172, 194), Acid Red dyes (No, 1, 8, 32, 35, 37, 52, 57, 92, 115, 119, 154, 249, 254, 256), Acid Blue dyes (No 1, 7, 9, 25, 40, 45, 62, 78, 80, 92, 102, 104, 113, 117, 127, 158, 175, 183, 193, 209), Acid Yellow dyes (No, 3, 7, 17, 19, 23, 25, 29, 38, 42, 49, 59, 61, 72, 73, 114, 128, 151), Direct Black dyes (No. 4, 14, 17, 22, 27, 38, 51, 112, 117, 154, 168), Direct Blue dyes (No. 1, 6, 8, 14, 15, 25, 71, 76, 78, 80, 86, 90, 106, 108, 123, 163, 165, 199, 226), Direct Red dyes (No. 1, 2, 16, 23, 24, 28, 39, 62, 72, 236). Direct Yellow dyes (No. 4, 11, 12, 27, 28, 33, 34, 39, 50, 58, 86, 100, 106, 107, 118, 127, 132, 142, 157), Reactive Dyes, such as Reactive Red Dyes (No. 4, 31, 56, 180), Reactive Black dyes (No. 31), Reactive Yellow dyes (No. 37); anthraquinone dyes, monoazo dyes, disazo dyes, phthalocyanine derivatives, including various phthalocyanine sulfonate salts, aza(18)annulenes, formazan copper complexes, and triphenodioxazines.

The composition of the humectant blend may be selected to convey desired properties to the ink composition. In particular, the composition of the humectant blend may be selected based upon HLB values of the individual components or alternately, based on the Hydrogen Bonding Force Hansen solubility parameter (δ_{b}) of the individual components to convey desired properties to the ink composition. Table 1 below summarizes calculated HLB values and the Hydrogen Bonding Force Hansen solubility parameter for a selected set of humectants that may be suitable for use in the disclosure herein. Without being limited by theory or mechanism, the amount of each humectant may be selected to balance ink latency and penetration, while still providing sufficient volatility to promote rapid ink drying. As such, selection of components with particular HLB values and amounts thereof may also be balanced with the normal boiling points of the components.

TABLE 1

| | | Hansen Hydrogen | Normal |
|---|---|---|---|
| | | Bonding Force | Boiling |
| | | (δₕ) | Point |
| Humectant | HLB | (MPa)^{1/2} | (° C.) |
| glycerol | 11 | 29.3 | 290 |
| 1,2-propanediol | 8.9 | 23.3 | 188.2 |
| 1,2-butanediol | 7.6 | n/a | 192 |
| 1,4-butanediol | 7.6 | 20.9 | 230 |
| 1,2-pentanediol | 6.5 | 16.8 | 206 |
| 1,2-hexanediol | 5.8 | n/a | 223° C. |
| 1,6-hexanediol | 5.8 | 17.3 | 249 |
| 1,2-hexanediol | 5.8 | 16 | 223.5 |
| 1,2-octanediol | 4.7 | n/a | 243° C. |
| 2-methyl-2,4-pentanediol | 5.5 | 17 | 197 |

The first component of the humectant blend (first humectant) may be highly hygroscopic and highly hydrophilic, which may aid in promoting nozzle health during printing latency. The first humectant may have a HLB value of about 10 or greater, or about 10.5 or greater, or about 11 or greater, such as about 10 to about 22, or about 10 to about 20, or about 10 to about 18. Alternately, the first humectant may be characterized by a Hansen Hydrogen Bonding Force (δₕ) in MPa^{1/2} of about 29 or greater, or about 27 or greater. Suitable examples of the first humectant may include, but are not limited to, polyhydric alcohols and alkoxylated forms thereof. Polyhydric alcohols include 3 or more hydroxyl groups. Illustrative examples of suitable first humectants may include, but are not limited to, glycerol, glycerol ethoxylate, polyethylene glycols, and any combination thereof. Suitable polyethylene glycols may include diethylene glycol, triethylene glycol, tetraethylene glycol, and PEG 200, for instance.

In non-limiting examples, the first humectant may comprise about 20 wt % or less, or about 15 wt % or less, or about 10 wt % or less, or about 5 wt % or less of the ink composition, based on total mass of the ink composition, such as about 1 wt % to about 12 wt %, or about 2 wt % to about 8 wt %, or about 2.5 wt % to about 6.5 wt %, based on total mass of the ink composition. Based on total mass of the humectant blend, the first humectant may comprise about 20 wt % or less of the humectant blend, such as about 8 wt % to about 18 wt %, or about 9 wt % to about 16 wt %, or about 9 wt % to about 12 wt %, or about 14 wt % to about 18 wt %.

The second component of the humectant blend (second humectant) may be less hydrophilic than the first humectant and primarily serve as a co-solvent for the ink composition. The second humectant may have a HLB value of about 7 to about 9.5, or about 7 to about 9, or about 7.5 to about 9. Alternately, the second humectant may be characterized by a Hansen Hydrogen Bonding Force (δₕ) in MPa^{1/2} of about 20 to about 24 or about 20 to about 26. Suitable examples of the second humectant may include, but are not limited to, C₂ to C₄ diols or C₃ to C₄ diols. Illustrative examples of suitable second humectants may include, but are not limited to, 1,2-propanediol, 1,3-propanediol, 1,2-butanediol, 1,3-butanediol, 1,4-butanediol, or any combination thereof. In some examples, the second humectant may comprise 1,2-propanediol, 1,2-butanediol, 1,3-butanediol, or any combination thereof. Other suitable second humectants may include, for example, ethylene glycol, ethylene glycol monomethyl ether, propylene glycol monomethyl ether, 3-methoxy-1-butanol, the like, or any combination thereof.

The second humectant may comprise a majority of the humectant blend on a mass basis, and may be present in an amount that is at least twice that of a combined amount of the first humectant and the third humectant in particular examples. In non-limiting examples, the second humectant may comprise about 35 wt % or less, or about 30 wt % or less, or about 25 wt % or less of the ink composition based on total mass of the ink composition, such as about 20 wt % to about 35 wt %, or about 22 wt % to about 30 wt %, or about 23 wt % to about 26 wt %, or about 26 wt % to about 29 wt %, based on total mass of the ink composition. Based on total mass of the humectant blend, the second humectant may comprise about 65 wt % or more or about 70 wt % or more of the humectant blend, such as about 70 wt % to about 90 wt %, or about 72 wt % to about 85 wt %, or about 74 wt % to about 80 wt %, or about 78 wt % to about 83 wt %.

To facilitate drying of the ink composition upon a print substrate, the second humectant may be selected to have a normal boiling point of about 230° C. or below, or about 220° C. or below, or about 210° C. or below, about 200° C. or below, or 190° C. or below. Optionally, the second humectant may comprise a blend of second humectants, wherein at least a majority (at least 50% by mass, or at least 60% by mass, or at least 70% by mass, or at least 80% by mass, or at least 90% by mass, or at least 95% by mass) of the second humectants have a normal boiling point of about 200° C. or below or about 195° C. or below, and a minority (about 50% by mass or less, or about 40% by mass or less, or about 30% by mass or less, or about 20% by mass or less, or about 10% by mass or less, or about 5% by mass or less) of the second humectants have a boiling point of about 200° C. or above, such as within a range of about 200° C. to about 230° C., or about 200° C. to about 210° C., or about 210° C. to about 230° C.

The third component of the humectant blend (third humectant) may be less hydrophilic than the second humectant and promote ink penetration into a print substrate. Good ink penetration may lessen the ink drying time and limit inter-color bleeding during printing. The third humectant may have a HLB value of about 7 or less, or about 6 or less, or about 5 or less, such as about 4 to about 7, or about 5 to about 7, or about 5.5 to about 6.5. Alternately, the third humectant may be characterized by a Hansen Hydrogen Bonding Force (δₕ) in MPa^{1/2} of about 20 or less, or about 18 or less, or about 16 or less. Suitable examples of the third humectant may include, but are not limited to, C₅-C₁₂, or C₅-C₁₀, or C₅-C₈ diols. Illustrative examples of suitable third humectants may include, but are not limited to, 1,2-pentanediol, 1,5-pentanediol, 1,2-hexanediol, 1,6-hexanediol, 1,2-octanediol, 1,8-octanediol, 2-methyl-2,4-pentanediol, or any combination thereof. Vicinal diols such as 1,2-pentanediol, 1,2-hexanediol, or 1,2-octanediol may be particularly suitable as the third humectant. Longer alkyl groups that are more hydrophobic may be desirable for increasing surface penetration, increasing the viscosity of the ink composition, and promoting particle growth in the ink composition.

In non-limiting examples, the third humectant may comprise about 10 wt % or less, or about 6 wt % or less, or about 4 wt % or less of the ink composition, based on total mass of the ink composition, such as about 1 wt % to about 5 wt %, or about 2 wt % to about 4 wt %, or about 2 wt % to about 3 wt %, based on total mass of the ink composition. Based on total mass of the humectant blend, the third humectant may comprise about 15 wt % or less of the humectant blend or about 10 wt % or less of the humectant blend, such as about 4 wt % to about 12 wt %, or about 5 wt % to about 10 wt %, or about 6 wt % to about 10 wt %.

In some embodiments, the first humectant may comprise glycerol, glycerol ethoxylate, polyethylene glycol, or any combination thereof; the second humectant may comprise 1,2-propanediol, 1,2-butanediol, 1,3-butanediol, or any combination thereof; and the third humectant may comprise 1,2-pentanediol, 1,2-hexanediol, 1,2-octanediol, 2-methyl-2,4-pentanediol, or any combination thereof. Any combination of the first, second, and third humectants may be used, wherein the wt % values for each of the humectants reside within the ranges specified above.

In some embodiments, the first humectant may comprise glycerol; the second humectant may comprise 1,2-propanediol, 1,2-butanediol, 1,3-butanediol, or any combination thereof; and the third humectant may comprise 1,2-hexanediol. Any combination of the first, second, and third humectants may be used, wherein the wt % values for each of the humectants reside within the ranges specified above.

Other suitable solvents that may be present in the ink compositions in combination with the foregoing first, second, and third humectants include, for example, 3-methoxy-1-butanol, diethyleneglycol monomethyl ether, ethylene glycol, diethylene glycols, dipropylene glycols, polyethylene glycols, polypropylene glycols, trimethylolpropane, 2-methyl-1,3, propanediol, 2-ethyl-2-hydroxymethyl-1,3-propanediol, 3-methoxybutanol, 3-methyl-1,5-pentanediol, 2,4-heptanediol, amides, ethers, urea, substituted ureas such as thiourea, ethylene urea, alkylurea, alkylthioureas, dialkylureas, and dialkylthioureas, carboxylic acids and their salts, such as 2-methylpentanoic acid, 2-ethyl-3-propylacrylic acid, 2-ethyl-hexanoic acid, 3-ethoxyproponic acid, organosulfides, organosulfoxides, sulfones (such as sulfolane), carbitol, butyl carbitol, cellusolve, tripropylene glycol monomethyl ether, ether derivatives, hydroxyethers, amino alcohols, ketones, N-methylpyrrolidinone, 2-pyrroidinone, cyclohexylpyrrolidone, amides, sulfoxides, lactones, polyelectrolytes, methyl sulfonylethanol, 1,3-dimethyl-2-imidazolidinone, substituted and unsubstituted formamides, substituted and unsubstituted acetamides, the like, or any combination thereof.

The ink compositions disclosed herein may include additional components as well. In non-limiting examples, the ink compositions may further comprise one or more of a surfactant, a defoamer, a wax, a biocide, a buffer, or any combination thereof. Suitable examples of the foregoing and amounts to include in an ink composition will be familiar to one having ordinary skill in the art. Surfactants may be selected, for example, to accommodate dynamic and static surface tension variations in the ink composition. Geminal neutral surfactants may be particularly suitable, for example.

The ink compositions may comprise still further additional additives as well Additional optional additives that may be included in the ink compositions include pH controlling agents such as acids or bases, buffers, chelating agents such as EDTA (ethylenediamine tetraacetic acid), viscosity modifiers, leveling agents, the like, and any combination thereof. When included, one having ordinary skill in the art will able to select suitable additives and amounts thereof.

Examples of suitable surfactants may include anionic surfactants, cationic surfactants, nonionic (neutral) surfactants, zwitterionic surfactants, and any combination thereof. Nonionic surfactants may be especially preferred. When included, the surfactant may be included in an amount of about 0.01 wt % to about 10 wt %, or about 0.01 wt % to about 5 wt %, about 0.0 wt % to about 2 wt %, based on total mass of the ink composition.

Examples of suitable surfactants may include, but are not limited to, silicon-containing surfactants, alcohol ethoxylates, ethoxylated polysiloxanes, alkyl polyethylene oxides, alkyl phenyl polyethylene oxides, polyethylene oxide block copolymers, acetylenic polyethylene oxides, and the like. More specific examples of suitable surfactants include, for instance, SURFYNOL series surfactants (Evonik), DYNOL series surfactants (Evonik), TERGITOL series surfactants (Dow), TEGO TWIN series surfactants (Evonik), TEGO WET series surfactants (Evonik), TEGO GLIDE series surfactants (Evonik), TEGO FLOW series surfactants (Evonik), and CARBOWET series surfactants (Evonik).

Accordingly, the present disclosure further provides ink compositions comprising: a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less; wherein the humectant blend comprises about 40 wt % or less of the ink composition based on total mass, and the first humectant comprises glycerol; the second humectant comprises 1,2-propanediol, 1,2-butanediol, 1,3-butanediol, or any combination thereof; and the third humectant comprises 1,2-hexanediol; a binder latex comprising a styrene-acrylate copolymer dispersed in the continuous phase; and a pigment dispersed in the continuous phase. Optionally, an amount of the second humectant may be at least twice that of a combined amount of the first humectant and the third humectant. Optionally, a polymeric dispersant may be dissolved in the continuous phase, wherein, if present, the polymeric dispersant may be anionic, have an acid number of about 200 or above, and have a weight average molecular weight (Mw) of about 7,000 to about 10,000.

Additionally, the present disclosure further includes inkjet printing methods using the above-described ink compositions. Such methods may comprise: ejecting an ink composition of the present disclosure though a jet stack of an inkjet printer, and receiving the ink composition upon a print substrate to form an image. Sneezing is not performed while the inkjet printer is operating. Optionally, alternative cleaning technique for maintaining health of the jet stack may be performed while the inkjet printer is not operating. Suitable inkjet printing processes will be familiar to persons having ordinary skill in the art and may include any of thermal inkjet processes, acoustic inkjet processes, piezoelectric inkjet processes, or any combination thereof.

Embodiments disclosed herein include the following:
A. Ink compositions. The ink compositions comprise: a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less; wherein the humectant blend comprises about 40 wt % or less of the ink composition based on total mass; optionally, a polymeric dispersant dissolved in the continuous phase; a binder resin dispersed or dissolved in the continuous phase; and a colorant dispersed or dissolved in the continuous phase.
A1. Ink compositions. The ink compositions comprise: a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less; wherein the humectant blend comprises about 40 wt % or less of the ink composition based on total mass, and the first humectant comprises glycerol; the second humectant comprises 1,2-propanediol, 1,2-butanediol, 1,3-butanediol, or any combination thereof; and the third humectant comprises 1,2-hexanediol; optionally, a polymeric dispersant dissolved in the continuous phase; wherein, if present, the polymeric dispersant is anionic, has an acid number of about 200 or above, and has a weight average molecular weight (Mw) of about 7,000 to about 10,000; a binder latex comprising a styrene-acrylate copolymer dispersed in the continuous phase; and a pigment dispersed in the continuous phase.
B. Inkjet printing methods. The methods comprise: ejecting the ink composition of A or A1 through a jet stack of an inkjet printer; wherein sneezing is not performed while the inkjet printer is operating; and receiving the ink composition upon a print substrate to form an image.

Each of embodiments A, A1 and B may include one or more of the following elements in any combination.
Element 1: wherein the ink composition further comprises one or more of a surfactant, a defoamer, a wax, a biocide, a buffer, or any combination thereof.
Element 2: wherein the binder resin comprises a binder latex dispersed in the continuous phase.
Element 3: wherein the binder latex comprises a styrene-acrylate copolymer.
Element 4: wherein the binder latex has a glass transition temperature of about 40° C. to about 70° C.
Element 5: wherein the binder latex has an average particle size of about 85 nm or below.
Element 6: wherein the binder latex comprises one or more acidic monomers in an amount of about 15 wt % or greater, based upon total mass of the binder latex.
Element 7: wherein the polymeric dispersant is present and is anionic.
Element 8: wherein the polymeric dispersant has an acid number of about 200 or above, and a weight average molecular weight (Mw) of about 7,000 to about 10,000.
Element 9: wherein the first humectant comprises glycerol, glycerol ethoxylate, polyethylene glycol, or any combination thereof; the second humectant comprises 1,2-propanediol, 1,2-butanediol, 1,3-butanediol, or any combination thereof; and the third humectant comprises 1,2-pentanediol, 1,2-hexanediol, 1,2-octanediol, 2-methyl-2,4-pentanediol, or any combination thereof.
Element 10: wherein the first humectant comprises glycerol; the second humectant comprises 1,2-propanediol, 1,2-butanediol, 1,3-butanediol, or any combination thereof; and the third humectant comprises 1,2-hexanediol.
Element 11: wherein the second humectant has a boiling point of about 200° C. or less.
Element 12: wherein an amount of the second humectant is at least twice that of a combined amount of the first humectant and the third humectant.
Element 13: wherein the colorant comprises a pigment, a dye, or any combination thereof.
Element 14: wherein the colorant comprises a pigment having a particle size of about 150 nm or below.
Element 15: wherein the colorant comprises a pigment, and the pigment comprises about 3 wt % to about 10 wt % of the ink composition, based upon total mass of the ink composition.

By way of non-limiting example, illustrative combinations applicable to A, A1, and B include, but are not limited to: 1 and 2; 1-3; 1, 2, and 4; 1-4; 1, 2, and 5; 1, 2, and 6; 1 and 7; 1, 7, and 8; 1 and 9; 1 and 10; 1, 9, and 11; 1, 10, and 11; 1, 9, and 12; 1, 10, and 12; 1, 9, 11, and 12; 1, and 10-12; 1 and 13; 1 and 14; 1, and 13-15; 1, 13, and 14; 1, 13 and 15; 2 and 3; 2 and 4; 2-4; 2, 3, and 5; 2 and 5; 2 and 6; 2, 4, and 6; 2, 5, and 6; 2 and 7; 2, 7, and 8; 2 and 9; 2 and 10; 2, 9, and 11; 2, 10, and 11; 2 and 12; 2, 10, and 12; 2, 9, 11, and 12; 2, and 10-12; 2 and 13; 2 and 14; 2 and 15; 2, and 13-15; 2, 13, and 14; 2, 13, and 14; 2, 13, and 15; 9 or 10, and 11; 9 or 10, and 12; 9 or 10, 11 and 12; 9 or 10, and 13; 9 or 10, and 14; 9 or 10, and 15; 9 or 10, and 13-15; 9 or 10, 13, and 14; or 10, 13, and 15; 9 or 10, 14, and 15; 11 or 12, and 13; 11 or 12, and 14; 11 or 12, and 15; 11 or 12, 13 and 14; 11 or 12, 13 and 15; 11 or 12, 14, and 15; 11 or 12, and 13-15; 13 and 14; 13 and 15; 14 and 15; and 13-15.

To facilitate a better understanding of the present disclosure, the following examples of preferred or representative embodiments are given. In no way should the following examples be read to limit, or to define, the scope of the invention.

### Examples

A styrene-acrylate latex dispersion was prepared as described below and used to formulate ink compositions having various colors. Magenta, cyan, yellow, and black ink compositions were formulated as specified in Table 2 below. Magenta, cyan, yellow, and black pigment dispersions were obtained from commercial sources and used as received. Other components of the ink compositions were also obtained from commercial sources.

The styrene-acrylate latex was prepared as follows. First, a reactive surfactant solution was prepared by mixing 2.75 g of a polyoxyethylene styrenated phenyl ether ammonium sulfate (HITENOL AR-2020) and 77 grams deionized water in a 500 mL three-neck roundbottom flask. The mixture was then purged with nitrogen for 30 minutes and heated at 80° C. with stirring. In a separate flask, the following were mixed and emulsified: 1.75 g of polyoxyethylene styrenated phenyl ether ammonium sulfate (HITENOL AR-2020); 1 g of 1-dodecanethiol (DDT); 4 g of bis[2-(methacryloyloxy)ethyl]phosphate (BMEP); 9 g of methacrylic acid (MMA); 26 g of n-butyl acrylate (BuA); 40 g of styrene (Sty), and 32 g deionized water. An initiator solution was prepared by mixing 0.8 g of ammonium persulfate (APS) initiator in 10 g of deionized water. Five volume percent (5 vol %) of the emulsified monomer mixture was fed into the roundbottom flask and held for 5 minutes at the heating temperature. Thereafter, 10 g of the initiator solution was added and held for 10 minutes at the heating temperature. Next, the rest of the emulsified monomer mixture was fed to the roundbottom flask slowly over 2.5 hours. When feeding of the monomer mixture was complete, the rest of the initiator solution was added to the roundbottom flask, and the reaction was allowed to continue for 3 hours at the heating temperature. After 3 hours, the reaction mixture was cooled to room temperature, and the resulting latex particles obtained from emulsion polymerization were filtered through a mesh and neutralized to pH 8.

A Nano-flex (Microtrac, Inc.) instrument was used to analyze the dimensions of the latex particles. The mean particle size of the latex was about 83 nm, with a second scan onset Tg about 48.5° C., as determined by differential scanning calorimetry.

The ink compositions in Table 2 were made following a general procedure by combining the humectants, surfactants and biocide in deionized water, followed by adding the latex particles and the pigment dispersion to the humectants. The first surfactant (Surf. 1) was SURFYNOL AD01 (geminal neutral surfactant), and the second surfactant (Surf. 2) was TEGO TWIN 4000 (geminal polysiloxane neutral surfactant), each of which may be obtained from Evonik.

TABLE 2

| | Pigment | Latex | 1,2- | 1,2- | 1,3- | | Surfactants | |
|---|---|---|---|---|---|---|---|---|
| | Loading | Loading | HD² | PD³ | BD⁴ | Glycerol | (wt %) | |
| Pigment | (wt %) | (wt %) | (wt %) | (wt %) | (wt %) | (wt %) | Surf. 1 | Surf. 2 |
| Magenta | 8.0¹ | 3.10 | 3 | 26 | — | 3 | 0.65 | 0.08 |
| Cyan | 3.6 | 2.14 | 3 | 28.66 | — | 3.2 | 1 | 0.045 |
| Yellow | 5.4 | 3.61 | 2 | 21.5 | 2 | 4.5 | 1 | 0.03 |
| Black | 5.5 | 1.50 | 3 | 25.86 | — | 6 | 1 | 0.048 |

¹Mixture of two magenta pigments (6.5% + 1.5% of first and second magenta pigments, respectively). Mixing of the magenta pigments was done to achieve a desired coloration state.
²HD = 1,2-hexanediol
³PD = 1,2-propanediol (propylene glycol)
⁴BD = 1,3-butanediol

The viscosity and surface tension properties of the ink compositions are summarized in Table 3 below.

TABLE 3

| | Viscosity | Surface Tension |
|---|---|---|
| Pigment | (cP) | (mN/m) |
| Magenta | 4.86 | 24.72 |
| Cyan | 2.89 | 25.90 |
| Yellow | 3.87 | 25.65 |
| Black | 3.86 | 26.46 |

As shown, the ink compositions of various colors had similar surface tension and viscosity values.

The ink compositions of various colors were printed using a Xerox Baltoro printer under similar conditions, with the exception that a one-drop sneeze setting was used for the cyan, yellow, and black inks, whereas a two-drop sneeze setting was used for the magenta ink (control printing conditions). The same inks were also printed using no-sneeze conditions (experimental printing conditions). Standard commercial inks of each color were also printed under each of the control and experimental printing conditions for comparison. The quality of the print under each set of printing conditions was characterized as the number of missing jets/kilo-print (mj/kp). Missing jets (mj) is defined as the number of jets that do not deposit an ink droplet or deposit an ink droplet greater than or equal to 35 μm off-target, as measured by an in-line quality scanner. The printing quality of each experimental ink composition was evaluated qualitatively in comparison to the commercial inks of each color under the control printing conditions (sneezing) or experimental printing condition (no sneezing). Results are summarized in Table 4.

TABLE 4

| | No Sneeze | 1-Drop Sneeze | 2-Drop Sneeze |
|---|---|---|---|
| Pigment | Printing | Printing | Printing |
| Magenta | better than | — | worse than |
| | commercial ink | | commercial ink |
| Cyan | better than | worse than | — |
| | commercial ink | commercial ink | |
| Yellow | better than | worse than | — |
| | commercial ink | commercial ink | |
| Black | better than | worse than | — |
| | commercial ink | commercial ink | |

Surprisingly, the printing performance of the experimental ink compositions exceeded the printing performance of the commercial inks under no-sneeze printing conditions. This result is surprising, given that the printing performance of each experimental ink composition was poorer than the commercial inks when printed under the control printing conditions (sneezing). Table 5 summarizes the missing jets/kilo-print (mj/kp) data for the experimental ink compositions under no-sneeze printing conditions and the commercial inks under one-sneeze or two-sneeze printing conditions. Based on the qualitative printing performance in Table 4, it may be inferred that the commercial inks exhibit greater mj/kp values than the corresponding experimental ink composition when printed under no-sneeze printing conditions.

TABLE 5

| | (mj/kp) | | |
|---|---|---|---|
| | Experimental Ink | Commercial | Commercial |
| | Compositions No- | Inks 1-Drop | Inks 2-Drop |
| Pigment | Sneeze Printing | Sneeze Printing | Sneeze Printing |
| Magenta | 0.06 | — | 0.83 |
| Cyan | 0.02 | 2.07 | — |
| Yellow | 11.99 | 12.72 | — |
| Black | 0.60 | 4.44 | — |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. An ink composition comprising:
a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less;
wherein the humectant blend comprises about 40 wt % or less of the ink composition based on total mass;
optionally, a polymeric dispersant dissolved in the continuous phase;
a binder resin dispersed or dissolved in the continuous phase; and
a colorant dispersed or dissolved in the continuous phase.

2. The ink composition of claim 1, further comprising:
one or more of a surfactant, a defoamer, a wax, a biocide, a buffer, or any combination thereof.

3. The ink composition of claim 1, wherein the binder resin comprises a binder latex dispersed in the continuous phase.

4. The ink composition of claim 3, wherein the binder latex comprises a styrene-acrylate copolymer.

5. The composition of claim 3, wherein the binder latex has a glass transition temperature of about 40° C. to about 70° C.

6. The composition of claim 3, wherein the binder latex has an average particle size of about 85 nm or below.

7. The ink composition of claim 3, wherein the binder latex comprises one or more acidic monomers in an amount of about 15 wt % or greater, based upon total mass of the binder latex.

8. The ink composition of claim 1, wherein the polymeric dispersant is present and is anionic.

9. The ink composition of claim 8, wherein the polymeric dispersant has an acid number of about 200 or above, and a weight average molecular weight (Mw) of about 7000 to about 10000.

10. The ink composition of claim 1, wherein the first humectant comprises glycerol, glycerol ethoxylate, polyethylene glycol, or any combination thereof; the second humectant comprises 1,2-propanediol, 1,2-butanediol, 1,3-butanediol, or any combination thereof; and the third humectant comprises 1,2-pentanediol, 1,2-hexanediol, 1,2-octanediol, 2-methyl-2,4-pentanediol, or any combination thereof.

11. The ink composition of claim 1, wherein the first humectant comprises glycerol; the second humectant comprises 1,2-propanediol, 1,2-butanediol, 1,3-butanediol, or any combination thereof; and the third humectant comprises 1,2-hexanediol.

12. The ink composition of claim 1, wherein the second humectant has a boiling point of about 200° C. or less.

13. The ink composition of claim 1, wherein an amount of the second humectant is at least twice that of a combined amount of the first humectant and the third humectant.

14. The ink composition of claim 1, wherein the colorant comprises a pigment, a dye, or any combination thereof.

15. The ink composition of claim 1, wherein the colorant comprises a pigment having a particle size of about 150 nm or below.

16. The ink composition of claim 1, wherein the colorant comprises a pigment, and the pigment comprises about 3 wt % to about 10 wt % of the ink composition, based upon total mass of the ink composition.

17. A method comprising:
ejecting the ink composition of claim 1 through a jet stack of an inkjet printer;
wherein sneezing is not performed while the inkjet printer is operating; and
receiving the ink composition upon a print substrate to form an image.

18. An ink composition comprising:
a continuous phase comprising water and a humectant blend comprising a first humectant having a hydrophilic-lipophilic balance (HLB) of about 10 or greater, a second humectant having a HLB ranging from about 7.5 to about 9, and a third humectant having a HLB of about 7 or less;
wherein the humectant blend comprises about 40 wt % or less of the ink composition based on total mass, and the first humectant comprises glycerol; the second humectant comprises 1,2-propanediol, 1,2-butanediol, 1,3-butanediol, or any combination thereof; and the third humectant comprises 1,2-hexanediol;
optionally, a polymeric dispersant dissolved in the continuous phase;
wherein, if present, the polymeric dispersant is anionic, has an acid number of about 200 or above, and has a weight average molecular weight (Mw) of about 7,000 to about 10,000;
a binder latex comprising a styrene-acrylate copolymer dispersed in the continuous phase; and
a pigment dispersed in the continuous phase.

19. The ink composition of claim 18, wherein an amount of the second humectant is at least twice that of a combined amount of the first humectant and the third humectant.

20. The ink composition of claim 18, wherein the binder latex has a glass transition temperature of about 40° C. to about 70° C.
